(19) United States
(12) Patent Application Publication
(10) Pub. No.: US 2017/0144047 A1
(43) Pub. Date: May 25, 2017

(54) Method and Apparatus for Rowing Analysis Assessment, and Coaching

(71) Applicant: Hegemony Technologies, Davis, CA (US)

(72) Inventor: Richard Paul Crawford, Davis, CA (US)

(73) Assignee: Hegemony Technologies, Davis, CA (US)

(21) Appl. No.: 15/355,055

(22) Filed: Nov. 18, 2016

Related U.S. Application Data
(60) Provisional application No. 62/258,368, filed on Nov. 20, 2015.

(51) Int. Cl. A63B 69/06; A63B 71/06; A63B 24/00; G09B 19/00

(52) U.S. Cl. CPC A63B 69/06; G09B 19/0038; A63B 71/0622; A63B 24/0062; A63B 24/0006; A63B 2225/50; A63B 2220/12; A63B 2220/44; A63B 2220/89; A63B 2220/836; A63B 2230/06; A63B 2230/42; A63B 2230/50; A63B 2230/60; A63B 2220/833; A63B 2071/0625; A63B 2071/0655

(57) ABSTRACT

A system for training in the sport of rowing. The system comprising of a number of sensors creating a tight coaching feedback loop. The system provides vast improvements in the metrics and analysis of rowing.

### CROSS-REFERENCE TO RELATED APPLICATIONS

This application claims priority to an earlier-filed provisional application No. 62/258,368. Confirmation No. 2808. Filed Nov. 20, 2015.

### STATEMENT REGARDING FEDERALLY SPONSORED RESEARCH OR DEVELOPMENT

None

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC (SEE §1.52(E)(5)). THE TOTAL NUMBER OF COMPACT DISCS INCLUDING DUPLICATES AND THE FILES ON EACH COMPACT DISC SHALL BE SPECIFIED

Not Applicable

### STATEMENT REGARDING PRIOR DISCLOSURES BY THE INVENTOR OR A JOINT INVENTOR

Not currently aware of relevant prior disclosures.

### BACKGROUND OF THE INVENTION

1. Field of the Invention

The general field of the invention is rowing technologies. The invention relates to systems and methods for tracking the performance of individual athletes and boat components in close detail so as to better ascertain their effectiveness and make needed corrections.

2. Background

The sport of rowing (and sculling—not differentiated for the purpose of this application) involves a significant number of mechanical and physiological factors that interact in a complex way. Individual rowing performance is affected by the biomechanics (how well you handle the oars, how well you handle the sliding seat, how well you position yourself to transfer power between the oar and the shell, etc.) and your physiologic ability to systematically transfer energy from the oar to the shell. When multiple people are in the boat, additional complexities arise in orchestrating the actions of all the rowers. Coaching plays a critical role in improving rowing proficiency and success.

Rowing coaching is traditionally done via a boat riding alongside the rowing shell with the coach shouting instructions to the rowers and/or coxswain. This form of coaching inherently creates numerous limitations as the coach can only work with what he/she is witnessing, analyzing, and instructing. Furthermore, the multiplicity of rowing factors and their complex interactions makes it very difficult if not impossible to quantitatively decompose rowing success (or failure) into its constitutive elements. Thus, rowing coaching (including self-coaching) largely has become an art developed through years of experience. In engineering terms, the “feedback loop” is neither precise nor tight.

### BRIEF SUMMARY OF THE INVENTION

This invention describes a system that uses sensors, communication systems, networks, standards, models, computing devices, and machine learning techniques to build deep insights into rowing cause/effect relationships and to create a tight feedback coaching loop. This system can work by itself or in concert with the traditional coach curating and augmenting the feedback. The system works in real-time during rowing workouts and races and as well as a post-workout assessment and planning tool. A particularly novel effect of this system is the ability to understand the sensitivities of rowing performance to proposed changes and thus create a prioritized set of coaching instructions. Additionally, the system makes it possible to tease out and distribute contributions of the shell performance to individuals within the boat.

### BRIEF DESCRIPTION OF THE SEVERAL VIEWS OF THE DRAWING

FIG. 1 depicts the major actors and infrastructure elements of the rowing analysis, and assessment coaching system.

FIG. 2 identifies the locations of the critical sensors and system components around a rower and on the boat.

FIG. 3 outlines the logical elements and functions of the analysis and assessment system and offers one embodiment of the network and data architecture that could be used to realize the system functionality.

FIG. 4 characterizes the general supervised learning methodology used to build, assess, and improve the model linking shell response and rower actions.

FIG. 5 illustrates one example of how individual rower performance can be graded relative to a designated standard and tracked over time to realize the learning curve of a rower.

### DETAILED DESCRIPTION OF THE INVENTION

### Definitions:

Any—one, some, or all indiscriminately of whatever quantity. As in “Any oar” would mean on one, all, or some of the oars in Any combination.
Orientation—the angular positioning of a device relative to a reference coordinate frame. In the case of rowing, the reference coordinate frame of interest is horizontal, vertical, and true or magnetic north. For boats, the orientation system is typically represented as roll, pitch, and yaw.
Motion—the movement of an object through space and time including all of its derivatives such as displacement, velocity, acceleration in both the rectilinear and angular dimensions.
Sensor Package—A Sensor Package is Any (see definition above) grouping of sensors, usually in a single enclosure, composed of Any of the following:
   1. Global Positioning System (GPS) or Any system that functions to identify location
   2. An Inertial Measuring Unit, which is composed of Any of the following:
      a. 3 Axis Accelerometer
      b. 3 Axis Angular Rate Gyroscope
      c. 3 Axis Magnetometer
   3. Wireless internet connectivity for things such as
      a. Time
      b. Weather
      c. Etc. . . . .
   4. Local network connectivity such as Bluetooth connectivity enabling communication amongst the elements of the Sensor Package.
   5. If the Sensor Package is attached to the human body than it also includes Any of the following:
      a. Heart rate or pulse sensor (heart rate)
      b. Respiration sensor (respiration rate)
      c. Temperature sensor (body temperature)
      d. Goniometer sensor (joint angles and body element Orientations)
      e. Electromyography sensor (muscle contraction)
Bio Feedback Device—refers to a device usually attached to a rower's body so that it can provide feedback to the rower based on programmed instructions from communication with the Sensor Package or other sources of input such as if the path of an oar exceeds a prescribed acceptable error band the Sensor Package or related actuator package may vibrate, make a noise, or provide some other active feedback to the rower. The device may be triggered by manual input or be pre-programmed. It may be in the form of an earpiece, a strap, a display mounted so it is visible to rower or coxswain or Any other suitable package so long it can deliver the needed information. It may also be an app interacting with a smartphone or other network connected devices.

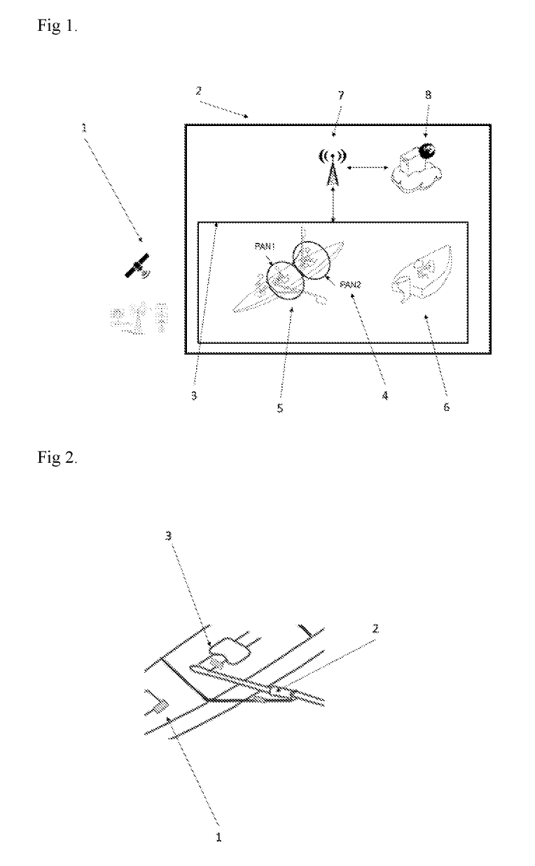

The system involves location, Orientation and Motion sensors placed on the shell of the boat, the oars, and the rower seats. The sensor systems are coupled as necessary with other systems and data sources needed to deliver their functionality, e.g., GPS satellites, world/atomic clocks, network time standards, network-based localization techniques, environmental data (weather, tide, etc.), physiologic sensors on the rowers (heart rate, respiration rate, perspiration, body temperature, etc.) and other contextually relevant information. The Sensor Packages each have processing and communication functionality that allows the sensor data to be transferred and analyzed as needed within personal area networks (PAN; one for each rower), local area networks (LAN; the shell, rowers, and coaching boat), and wide area networks (WAN; providing additional analysis resources). See FIG. 1 for an overview of the actors and infrastructural elements of the system, FIG. 2 for close up of Sensor Package embodiments involving the oar, seat, and shell, and FIG. 3 for an embodiment of the logic, data flow, and functionality necessary to realize the potential of the system.

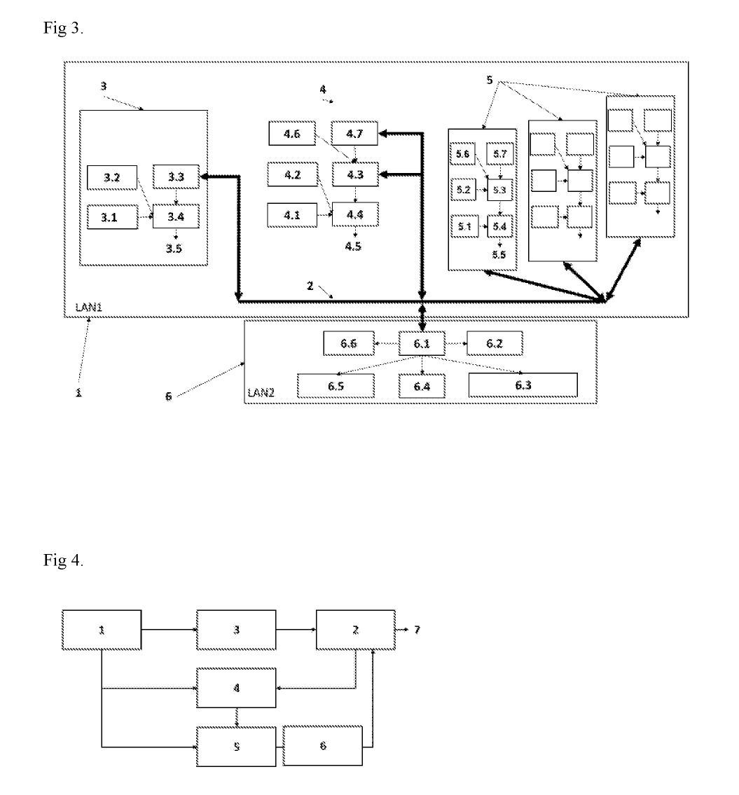

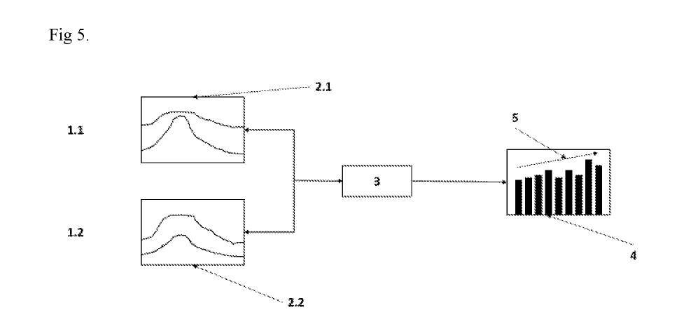

The system uses the sensor information with other contextually relevant data and employs standard machine learning techniques to construct a model of the rower/shell system that is specific to the training or racing configuration. This model is iteratively refined as additional “training data set” information is accumulated throughout a rowing event. The model can then be used to conduct sensitivity analysis of boat performance as a function of perturbations about each rower action. The effect of each perturbation can then be used to quantitatively predict the resulting change in boat response and thus create a prioritization of coaching instructions based on its predicted impact on shell performance. Each set of data (vector) on oar and seat Motions for each rower is compared to one (or more) standard of rowing mechanics and deviations are identified for potential corrective instruction and scored to measure training progress. A generic characterization of the model development methodology is depicted in FIG. 4.

The system can utilize several different feedback methods and channels based on the chosen coaching criteria and training/racing plan. Individual rower analysis can be conducted at the personal area network level with standard machine learning classification techniques to identify and correct identified deviations of oar and seat management from assigned standards, e.g., “rushing the slide”, “hands away too slow”, “oar too deep” could be communicated to an individual rower. The individual rower data and shell performance data can then be assembled within the local area network to build insights into the individual and collective effects of what is going on with the shell. For example, the system might identify that seat 3 is consistently late in their catch timing relative to seat 4 and thus suggest an appropriate corrective action. Lastly, all of these data can be streamed through a wide-area network to resources that store and process this data for a number of purposes, including but not limited to more complex sensitivity analyses, simulations, grading of rower performance, and additional refinements of models, assigned rowing standards, and training/racing plans.

The system could be configured to work in an automated feedback fashion in accordance with a defined criteria. For example, feedback could be blocked for certain instructions during certain workout time periods or the feedback could be limited to instructions that would be expected to achieve performance results that exceed a certain threshold. The system can be made to work in concert with a coxswain and/or coach as a higher level authority that is approving or blocking instruction based on more global information, e.g., a grander training plan, individual athlete psychologies, conditioning priorities, etc. The system may utilize several different communication channels. One channel may issue discreet individual instructions to each rower through Any number of channels, e.g., an audio earpiece that only the individual rower can hear, a tactile feedback system that only the rower can feel, a visual channel that only the individual rower can see. Another channel may involve a more general broadcast to the boat through audio, visual, or tactile systems either through a speaker, coxswain, or coach instruction.

The system can synthesize the results of Any portion of the workout into Any number of scoring systems relative to a chosen standard or metric. For example, an oar or seat control metric that scores locations, velocities, and accelerations against a known standard could be derived from the workout and published. The scores could be compared to trends for a specific rower or a group of rowers to measure their progress against a prescribed learning curve. With the use of system that can measure individual rower actions, shell performance, and a model of the relationship between these data, it would be possible to predict the energetic (work) contributions that rowers individually make on a shell. Thus, it will be possible to quantitatively assign and rank rowers based on their individual “boat moving” index. FIG. 5 illustrates the general idea of grading and trending rowing performance.

One embodiment of the invention involves the use of smartphones and a resident application to control the use of the integrated smartphone sensors, network and communication systems, and processing functionality. Modern smartphones universally possess precision clocks, PAN/LAN/WAN network communication functionality, GPS functionality, and inertial measurement units that measure linear accelerations, angular velocities, and magnetic fields in all 3 degrees of freedom. A smartphone could be securely attached to an oar though Any number of fixation techniques (armband, straps, Velcro, wraps, etc.) and be used to measure oar location, Orientation, and Motions through the inertial measurement unit sensors. Of particular interest in the rowing environment will be the location, rotation, and rotation rates of the oar blade throughout the stroke cycle (catch, drive, release, recovery). Another smartphone could be attached to a rowing seat or waist of a rower to measure the linear Motions of the seat along the seat track and used to determine the so-called slide control and that the rower is effecting. Synchronizing the oar and seat/waist information within the PAN makes it possible to analyze the sequencing of the rower's hands and legs. Within this personal area neatwork, there may be additional actuators/devices to deliver feedback, e.g., watches with haptic engines, ear pieces with speakers, or LEDs for communicating information. Another smartphone can be attached to the boat through Any number of fixation techniques, e.g., suction cups, straps, Velcro, etc. and the GPS functionality and IMUs could be used for high precision measures of boat velocity, Orientation, and dynamics, e.g., impulse/accelerations associated with each stroke of the boat.

Another embodiment of the PAN elements in the system could involve simple peripheral devices like activity trackers in place of a smartphones. For example, a smartphone could be affixed to the oar as described in the previous embodiment and be paired in the PAN (e.g., via Bluetooth) with a simple activity tracker attached to the rowing seat. Together, the smartphone and activity tracker would constitute a complete sensor, communication, and processing system for an individual rower.

An embodiment of the model derivation methods involve machine learning algorithms like time-series analysis, neural networks, Markov models, Bayesian networks, and ensemble techniques. It is anticipated that in addition to real time measures of rower mechanics and shell performance, there are contextually relevant information intrinsic to each rower that will prove to be important, e.g., individual power output measured on a rowing ergometer, real-time measures of heart rate, historical measures of the aforementioned “boat moving” index, etc.

An embodiment of the coaching analysis logic could involve techniques that learn to classify data in the language of rowing by using “training data” classified by an expert. For example, a machine could be taught to recognize and classify ‘washing out’, characterized by pulling the oar out of the water too early, by using data collected on oar handle position and velocities classified and validated through video by a coach as ‘washing out’ or ‘not washing out’.

An embodiment of the coaching instruction assessment could involve the check against a set of predefined criteria, e.g., 1) communication of an identified problem that reduces boat speed more than 1% on 3 consecutive strokes or 2) a system of cued recommendations in the coach or coxswain system that lists actions prioritized by their effect. The coach or coxswain could select the instructions and the means of communication on a smartphone or tablet with in the LAN.

One embodiment of a grading system could involve the use of a function that scores performance based on penalties for deviations from an established norm or model standard(s). The oar and seat/waist Motions recorded for a rower over a chosen series of strokes could be compared to those of an idealized Motion or those of an elite rower standard with a grade assigned based on some desired bound, e.g., “oar position within 1 inch of the standard 81% of the time” or “oar position within 2” of standard 94% of the time”. These grades could further be compared to some demographic or experience-based norm, e.g., “scores are 74th percentile for rowers in your age group and 38th percentile for rowers with 10-15 years of experience”. Of particular interest to an athlete would be how these grades evolved over time, i.e., how one is progressing against a target learning curve.

One embodiment of the individualization of rowing performance could involve the simple aggregation of the estimated translational energies imparted on a boat over a set period of time or event. For example, the rowers in seats 3 and 4 may be responsible for 18% and 20% of the energies generated for shell speed in drill 1 but only 11% and 15% of the energies generated for shell speed in drill 2.

One embodiment of the peak performance elicitation is utilizing information on current or historical physiologic status (HR, lactic acid status, rowing efficiency/effectiveness, etc.), contextual or environmental conditions, and sensitivity analysis of the model to perturbations to maximize the probability of a desired result. It could be that tide or environmental conditions during a race will effectively make the distance longer or shorter than planned and thus justify real-time race replanning.

The invention consists of the following elements:
1. A system of sensors for gathering data concerning rowing comprising:
   A Sensor Package located on Any oar which measures and analyzes the Motions, location, and Orientation of the oar and the boat.
2. A system of sensors for gathering data concerning rowing comprising:
   A Sensor Package attached to the waist of the rower which measures and analyzes the Motion of the boat, the rower, and the rowers' physiological attributes and characteristics.
3. A system of sensors for gathering data concerning rowing comprising:
   A Sensor Package attached to the boat which analyzes the Motions, location, and Orientation of the boat.
4. The system of claim 1 further comprising a Sensor Package attached to the waist of the rower which measures and analyzes the Motion of the boat, the rower, and the rowers' physiological attributes and characteristics.
5. The system of 4 further comprising a Sensor Package attached to the boat which analyzes the Motions, location, and Orientation of the boat.
6. The system of claim 2 further comprising a Sensor Package attached to the boat which analyzes the Motions, location, and Orientation of the boat.
7. The system of claim 1 further comprising of a Bio Feedback Device attached to the rower.
8. The system of claim 2 further comprising of a Bio Feedback Device attached to the rower.
9. The system of claim 3 further comprising of a Bio Feedback Device attached to the rower.
10. The system of claim 4 further comprising of a Bio Feedback Device attached to the rower.
11. The system of claim 5 further comprising of a Bio Feedback Device attached to the rower.
12. The system of claim 6 further comprising of a Bio Feedback Device attached to the rower.
   FIG. 1. The major actors and infrastructure elements of the analysis, assessment and coaching system.
1. Any of a variety of external signal sources that provide meaningful information to the system. This includes but is not limited to signals on location (e.g., GPS) and time (e.g., atomic clock).
2. The Wide Area Network (WAN) or the broad network made available by a variety of connections (backhaul, etc.).
3. The Local Area Network (LAN) or the network created by devices communicating in near proximity to each other.
4. The Personal Area Networks (PAN) or the networks created by devices communicating with other devices linked to a specific entity (in this case, an individual). One per device.
5. A boat shell with rower(s) and potentially a coxswain that collectively represent a rowing system of interest.
6. A boat that is observing the rowing shell, that is a coach, that is connected via a LAN and/or WAN to see data and analysis generated from the rowing system of interest.
7. A cellular tower (or Any of WAN infrastructure that connects data from the LAN to network)
8. Cloud resources that are used by the system to storage, process, and analyze data.
   FIG. 2. This figure zooms in on regions of particular interest in this invention: the area where the coxswain sits and the rower's seat and oar.
1. Sensor Package and coxswain interface affixed to boat. This system can be attached to the boat so that boat Motions will be mirrored in the package and thus recorded with system instrumentation. The display on the interface provides real-time feedback and analytics to a coxswain for their use in on-the-water coaching.
2. Sensor Package connected to the oar. The system will be attached so that oar Motions will be reflected in the package and thus recorded with system instrumentation.
3. Sensor Package connected to a rower's seat. The system will be attached in such a way that the seat Motions will be reflected in the package and thus recorded with system instrumentation. An alternative, or additional mounting of this system might be more directly to the body of the rower, e.g., with a pouched belt that would hold the package tightly to the waist of the rower and thus reflect Motions of the seat.
   FIG. 3. Demonstrates the general logical elements and functions of the analysis, assessment, and coaching system that offers one embodiment of the network and data architecture that could be used to realize the system functionality.
1. LAN1: The LAN elements and their functions that work and exchange data.
2. The data bus represents a logical pathway by which communications occur between the different elements and physical system.
3. The coaching functions and interfaces to the system. This includes the data and functions of (3.1) training plans, (3.2) coaching criteria, (3.3) analysis, (3.4) assessment, and (3.5) instructions.
4. The coxswain functions and interfaces to the system. This includes the (4.6) instrumentation, (4.7) models, (4.1) training plans, (4.2) coaching criteria, (4.3) analysis, (4.4) assessment, and (4.5) instructions.
5. The rower functions and interfaces to the system. This includes the (5.6) instrumentation, (5.7) rowing standards, (5.1) training plans, (5.2) coaching criteria, (5.3) analysis, (5.4) assessment, and (5.5) instructions. The image shows multiple iteration for up to X number of rowers.
6. Additional resources outside of LAN1 that could be brought to bear for (6.1) storage, (6.1) general analysis, (6.2) simulation, etc. work (6.3) updating models and plans, (6.4) grading rowers, (6.5) environmental data, and (6.6) sensitivity analysis. Includes but is not limited to resources in the Cloud.
   FIG. 4. Demonstrates the general supervised learning methodology used to build, assess, and improve the model linking (1) Rower Actions and (2) Shell Response:
1. The Rowers' Actions create a Shell Response through some (3) Unknown Dependency.
2. (4) Data on performance is collected through the use of the invention.
3. The Data is used to create a (5) Model and generate a (6) Prediction
4. The Prediction is compared with measured Shell Responses to refine the Model. Thereby continuously reducing the (7) Prediction Error
   FIG. 5. One example of how individual rower performance can be graded relative to a designated standard and tracked over time to realize the learning curve of a rower.
1. 1.1 and 1.2 are two competing sets of data such as 2 rowers or a set of predictions and a rower.
2. 2.1 and 2.2 represent the collected data for various factors such as the motion of the rower's seat, or position of the oars over time for each of the datasets.
3. The data is compared though various methods and graded along various rubrics such as speed and efficiency.
4. Represents the tracking of the comparisons over time establishing trend lines that represent how the rower is progressing along a (5) Learning Curve.

1. A system of sensors for gathering data concerning rowing comprising:
A Sensor Package located on Any oar which measures and analyzes the Motions, location, and Orientation of the oar and the boat.

2. A system of sensors for gathering data concerning rowing comprising:
A Sensor Package attached to the waist of the rower which measures and analyzes the Motion of the boat, the rower, and the rowers' physiological attributes and characteristics.

3. A system of sensors for gathering data concerning rowing comprising:
A Sensor Package attached to the boat which analyzes the Motions, location, and Orientation of the boat.

4. The system of claim 1 further comprising a Sensor Package attached to the waist of the rower which measures and analyzes the Motion of the boat, the rower, and the rowers' physiological attributes and characteristics.

5. The system of 4 further comprising a Sensor Package attached to the boat which analyzes the Motions, location, and Orientation of the boat.

6. The system of claim 2 further comprising a Sensor Package attached to the boat which analyzes the Motions, location, and Orientation of the boat.

7. The system of claim 1 further comprising of a Bio Feedback Device attached to the rower.

8. The system of claim 2 further comprising of a Bio Feedback Device attached to the rower.

9. The system of claim 3 further comprising of a Bio Feedback Device attached to the rower.

10. The system of claim 4 further comprising of a Bio Feedback Device attached to the rower.

11. The system of claim 5 further comprising of a Bio Feedback Device attached to the rower.

12. The system of claim 6 further comprising of a Bio Feedback Device attached to the rower.
